(19) United States
(12) Patent Application Publication
(10) Pub. No.: US 2025/0245844 A1
(43) Pub. Date: Jul. 31, 2025

(54) CALIBRATING A THREE-DIMENSIONAL SENSOR

(71) Applicant: Magik Eye Inc., Stamford, CT (US)

(72) Inventor: Akiteru Kimura, Tokyo (JP)

(21) Appl. No.: 18/855,623

(22) PCT Filed: Apr. 10, 2023
(86) PCT No.: PCT/US2023/018068

§ 371 Date: Oct. 9, 2024

Related U.S. Application Data
(60) Provisional application No. 63/329,879, filed on Apr. 11, 2022.
(60) Provisional application No. 63/329,884, filed on Apr. 11, 2022.
(60) Provisional application No. 63/329,885, filed on Apr. 12, 2022.

(51) Int. Cl. G06T 7/521; G06T 7/55; G06T 7/80

(52) U.S. Cl. CPC G06T 7/521; G06T 7/55; G06T 7/80

(57) ABSTRACT

An example method includes controlling a projecting subsystem of a distance sensor to project a projection pattern onto a target object, wherein the projection pattern comprises a plurality of points of light, controlling an imaging subsystem of the distance sensor to capture a first image of the projection pattern on the target object and an external camera having a fixed position to capture a second image of the projection pattern on the target object, calculating an image position of a first point of the plurality of points on an image sensor of the imaging subsystem, calculating a spatial position of the first point on the target object, based on the second image, and storing the image position and the spatial position together as calibration data for the distance sensor.

### CROSS REFERENCE TO RELATED APPLICATIONS

This application is a national stage application of PCT/US2023/018068, filed on Apr. 10, 2023, which claims the priority of U.S. Provisional Patent Application Ser. No. 63/329,879, filed Apr. 11, 2022; U.S. Provisional Patent Application Ser. No. 63/329,884, filed Apr. 11, 2022; and U.S. Provisional Patent Application Ser. No. 63/329,885, filed Apr. 12, 2022, all of which are herein incorporated by reference in their entireties.

### BACKGROUND

U.S. patent application Ser. Nos. 14/920,246, 15/149,323, and 15/149,429 describe various configurations of three-dimensional distance sensors. Such distance sensors may be useful in a variety of applications, including security, gaming, control of unmanned vehicles, and other applications.

The distance sensors described in these applications include light projecting subsystems (e.g., comprising lasers, diffractive optical elements, and/or other cooperating components) which project beams of light in a wavelength that is substantially invisible to the human eye (e.g., infrared) into a field of view. The beams of light spread out to create a projection pattern (of points, which may take the shape of dots, dashes, or other shapes) that can be detected by imaging subsystems (e.g., lenses, cameras, and/or other components) of the distance sensors. When a projection pattern projected by the projecting subsystem is incident upon an object in the field of view of the imaging subsystem, the distance from the distance sensor to the object can be calculated based on the appearance of the projection pattern (e.g., the positional relationships of the points) in one or more images of the field of view, which may be captured by the imaging subsystem. The shape and dimensions of the object can also be determined.

For instance, the appearance of the projection pattern may change with the distance to the object. As an example, if the projection pattern comprises a pattern of dots, the dots may appear smaller and closer to each other when the object is closer to the distance sensor, and may appear larger and further away from each other when the object is further away from the distance sensor.

### SUMMARY

An example method includes controlling a projecting subsystem of a distance sensor to project a projection pattern onto a target object, wherein the projection pattern comprises a plurality of points of light, controlling an imaging subsystem of the distance sensor to capture a first image of the projection pattern on the target object and an external camera having a fixed position to capture a second image of the projection pattern on the target object, calculating an image position of a first point of the plurality of points on an image sensor of the imaging subsystem, calculating a spatial position of the first point on the target object, based on the second image, and storing the image position and the spatial position together as calibration data for the distance sensor.

In another example, a non-transitory machine-readable storage medium is encoded with instructions executable by a processor of a distance sensor, wherein, when executed, the instructions cause the processor to perform operations. The operations include controlling a projecting subsystem of the distance sensor to project a projection pattern onto a target object, wherein the projection pattern comprises a plurality of points of light, controlling an imaging subsystem of the distance sensor to capture a first image of the projection pattern on the target object and an external camera having a fixed position to capture a second image of the projection pattern on the target object, calculating an image position of a first point of the plurality of points on an image sensor of the imaging subsystem, calculating a spatial position of the first point on the target object, based on the second image, and storing the image position and the spatial position together as calibration data for the distance sensor.

In another example, an apparatus includes a processing system including at least one processor and a non-transitory machine-readable storage medium encoded with instructions executable by the processing system. When executed, the instructions cause the processing system to perform operations. The operations include controlling a projecting subsystem of the distance sensor to project a projection pattern onto a target object, wherein the projection pattern comprises a plurality of points of light, controlling an imaging subsystem of the distance sensor to capture a first image of the projection pattern on the target object and an external camera having a fixed position to capture a second image of the projection pattern on the target object, calculating an image position of a first point of the plurality of points on an image sensor of the imaging subsystem, calculating a spatial position of the first point on the target object, based on the second image, and storing the image position and the spatial position together as calibration data for the distance sensor.

### BRIEF DESCRIPTION OF THE DRAWINGS

FIG. 1 is a block diagram illustrating a system for calibrating a three-dimensional sensor, according to examples of the present disclosure;

FIG. 2 illustrates one example of the projection pattern that may be projected onto the target surface of FIG. 1;

FIG. 3 is a flow diagram illustrating one example of a method for calibrating a three-dimensional sensor for distance measurement, according to the present disclosure; and

FIG. 4 depicts a high-level block diagram of an example electronic device for calibrating a three-dimensional distance sensor.

### DETAILED DESCRIPTION

The present disclosure broadly describes an apparatus, method, and non-transitory computer-readable medium for calibrating a three-dimensional sensor using detection windows. As discussed above, a three-dimensional distance sensor such as the sensors described in U.S. patent application Ser. Nos. 14/920,246, 15/149,323, and 15/149,429 determines the distance to an object (and, potentially, the shape and dimensions of the object) by projecting beams of light that spread out to create a projection pattern (e.g., of points, which may take the shape of dots, dashes, or other shapes) in a field of view that includes the object. The beams of light may be projected from one or more laser light sources which emit light of a wavelength that is substantially invisible to the human eye, but which is visible to an appropriate detector (e.g., of the distance sensor's imaging subsystem). The distance to the object may then be calculated based on the appearance of the projection pattern to the detector.

For instance, the spatial position (e.g., x,y,z coordinates) of a projected point on an object relative to the distance sensor may be calculated using the image position (e.g., u,v) of the corresponding point on the detector of the imaging subsystem's camera. In order to ensure the accuracy of this calculation, however, the distance must first be properly calibrated by measuring and storing a mapping between the spatial position of the projected point on the object and the image position of the corresponding point on the detector.

Conventional methods for calibrating a three-dimensional sensor such as the system described above may utilize two different calibration patterns. The three-dimensional sensor may capture a first plurality of images (e.g., at different tilt angles) of first calibration pattern, which may have a checkerboard pattern, using a camera of the three-dimensional sensor's imaging subsystem (i.e., a camera that is integrated or built into the three-dimensional sensor). The viewing angle and optical specifications of the camera may then be calculated from information extracted from the first plurality of images and used to calibrate the camera.

Once the camera is calibrated, the camera may subsequently capture a second plurality of images (e.g., at different distances from a target surface) of a projection pattern that is projected onto a second calibration pattern. In this case, the second calibration pattern may comprise a blank (e.g., white or grey) space surrounded by a patterned border, where the patterned border may comprise several rows of dots. The projection pattern may be projected onto the blank space of the second calibration pattern and may comprise a pattern of points as described above. Using the second plurality of images and the knowledge of the camera's viewing angle and optical specifications, the spatial positon (e.g., x,y,z coordinates) of each point on the second calibration pattern and the image position (e.g., u,v coordinates) of each point on the camera's detector may be calculated (or estimated through interpolation and extrapolation) and stored in association with each other.

This conventional calibration technique avoids the need for mechanical accuracy (except for in the calibration patterns) by performing an initial calibration of the camera with the first calibration pattern. Positional relationships can then be obtained through conventional image processing techniques. Moreover, since the origin of the coordinates of the three-dimensional (x,y,z) data corresponds to the principal point of the camera, it is relatively easy to reconstruct a three-dimensional image by superimposing the three-dimensional data on a two-dimensional image captured by the camera (e.g., an infrared image in the same wavelength range as the projecting subsystem of the three-dimensional sensor).

However, this conventional calibration technique tends to be processing-intensive. Moreover, it can be difficult to accurately detect the calibration targets, as well as the projection pattern, due to the camera focus shifting as the distance to the target surface changes; thus, additional processing may be required to correct for these focus shifts. Additionally, the optimal exposure conditions for capturing images of the calibration patterns and the projection pattern may be different, which may necessitate capturing images under a plurality of different conditions (e.g., camera settings and lighting) for both the calibration patterns and the projection pattern. It may also be necessary to change calibration patterns (e.g., use a pattern of a different size, pattern configuration, etc.) during the calibration process. In addition, since the origin of the coordinate system and spatial position (e.g., x,y,z, coordinates) of each artifact that are obtained through the conventional calibration technique are not associated with any physical coordinate reference, precision measurement, alignment with other equipment, and/or other processing may be needed to establish an association with a physical coordinate reference. Thus, many factors may add to the processing and manual labor needed to perform conventional calibration techniques.

Examples of the present disclosure introduce a second camera, external to and separate from the three-dimensional sensor, which has a fixed position with respect to the target surface. In this arrangement, the only positional relationship that changes is the distance between the target surface and the three-dimensional sensor. The spatial positon of each point of the projection pattern may be determined from images captured by the external camera and correlated with an image position of the point as determined from images captured by the distance sensor's imaging subsystem. The spatial position and image position for each point may then be stored as calibration data. The disclosed approach eliminates the need for any calibration patterns in the calibration process and relies on measurements of a projection pattern. Thus calibration is achieved based on machine accuracy, rather than the known dimensions of a calibration pattern.

Within the context of the present disclosure, the “image position” of a point of a projection pattern is understood to refer to the two-dimensional position of the point on an image sensor of a camera (e.g., a camera of a distance sensor's imaging subsystem). The “spatial position” of the same point is understood to refer to the position of the point on a target surface in a three-dimensional space. The point's image position may be expressed as a set of (u, v) coordinates, while the point's spatial position may be expressed as a set of (x, y, z) coordinates. Furthermore, an “external camera” is understood to refer to a camera that is not contained within the same housing as the imaging subsystem and projecting subsystem of the distance sensor. A processor of the distance sensor may still be able to communicate with the external camera to provide instructions for control of the external camera, however.

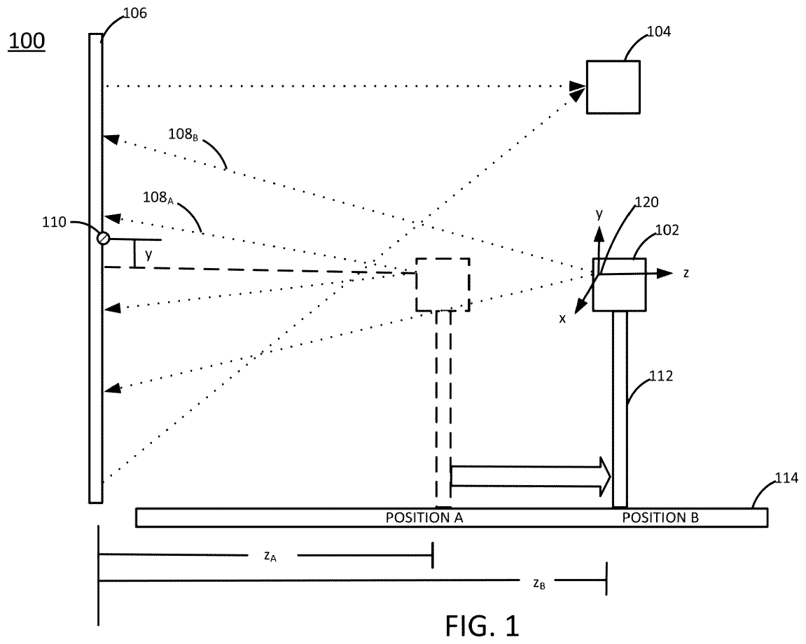

FIG. 1 is a block diagram illustrating a system 100 for calibrating a three-dimensional sensor, according to examples of the present disclosure. In one example, the system 100 generally comprises a distance sensor 102, an external camera 104, and a target surface 106.

The distance sensor 102 may be used to detect the distance to an object or surface, such as the target surface 106 or other objects. In one example, the distance sensor 102 shares many components of the distance sensors described in U.S. patent application Ser. Nos. 14/920,246, 15/149,323, and 15/149,429. For instance, in one example, the distance sensor 102 may comprise a light projecting subsystem, an imaging subsystem, and a processor, all contained within a common housing.

In one example, the light projecting subsystem of the distance sensor 102 may be arranged in a manner similar to any of the arrangements described in U.S. patent application Ser. No. 16/701,949. For instance, the light projecting subsystem may generally comprise a laser emitter, a lens, and a diffractive optical element (DOE). The light projecting subsystem may be arranged to emit a plurality of beams of light in a wavelength that is substantially invisible to the human eye (e.g., infrared light). In one example, when each beam of light is incident upon an object or surface such as the target surface 106, the beam may create a point of light (e.g., a dot, a dash, or the like) on the surface. Collectively, the points of light created by the plurality of beams of light form a projection pattern from which the distance to the surface can be calculated. For instance, the projection pattern may comprise a grid in which a plurality of points is arranged in a plurality of rows and columns.

The imaging subsystem of the distance sensor 102 may comprise a camera that is configured to capture images including the projection pattern. The camera may include an image sensor comprising a plurality of photodetectors (or pixels) that are sensitive to different wavelengths of light, such as red, green, blue, and infrared. For instance, the photodetectors may comprise complementary metal-oxide-semiconductor (CMOS) photodetectors.

The processor of the distance sensor 102 may control operation of the projecting subsystem and imaging subsystem. The processor may also communicate (e.g., via a wired and/or wireless communication interface) with systems and devices external to the distance sensor 102, such as the external camera 104. In further examples, the processor may also process images captured by the imaging subsystem in order to calculate the distance to an object or surface on which the projection pattern is projected. For instance, the distance may be calculated in accordance with the methods described in U.S. patent application Ser. Nos. 14/920,246, 15/149,323, and 15/149,429.

In one example, the distance sensor 102 may be mounted to a support 112. The support 112 may support the distance sensor 102 in such a way that the x and y coordinates of the distance sensor 102 in a three-dimensional space are fixed. However, in one example, the support 112 may be movable in one direction (e.g., the z direction in the three-dimensional space). For instance, the support 112 may be coupled to a track 114 that allows the z coordinate of the support 112, and, consequently, the z coordinate of the distance sensor 102, to be varied.

The external camera 104 comprises a camera that is separate from the distance sensor 102. The external camera 104 is “external” in the sense that the external camera 104 is not contained within the housing of the distance sensor 102 (unlike the camera of the distance sensor's imaging subsystem). For instance, the external camera 104 may comprise a separate RGB, infrared, or other type of camera that is mounted in a fixed position within the system 100. Although FIG. 1 illustrates a single external camera 104, the system 100 may in other examples include multiple external cameras, where the position of each external camera of the multiple external cameras is known and fixed (and where each external camera of the multiple external cameras has a different known and fixed position). The use of multiple external cameras may minimize blind spots for the system 100 and facilitate better response to changes in the spread of the points of the projection pattern due to movement of the distance sensor 102.

The target surface 106 may comprise a flat screen or other solid surfaces. The target surface 106 may be of a solid, uniform color, such as white (e.g., may be blank). The target surface 106 may comprise an inflexible surface or a flexible surface. In one example, the target surface 106 has a uniform reflectance.

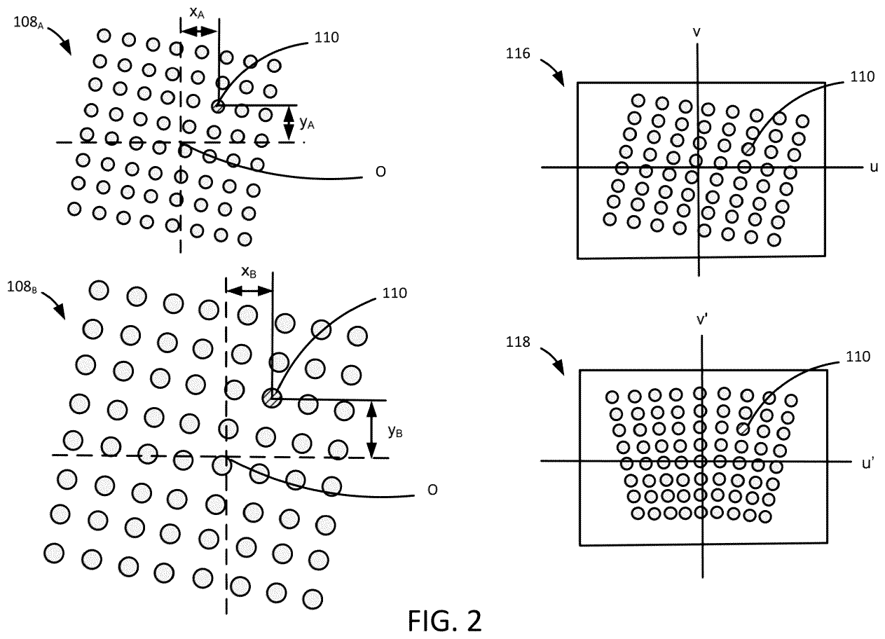

In one example, distance sensor 102, external camera 104, and target surface 106 cooperate to calibrate the distance sensor 102 for use in distance detecting. For instance, the distance sensor 102 may be positioned at a first position, such as Position A, along the track 114. Position A in this case may have three-dimensional coordinates of (x,y,Z_{A}). The distance sensor 102 may project a projection pattern 108_{A} onto the target surface 106 from Position A. Both the distance sensor 102, and the external camera 104 (whose position relative to the target surface 106 is fixed) may then capture images of the projection pattern 108_{A} on the target surface 106. FIG. 2, for instance, illustrates one example of the projection pattern 108_{A} that may be projected onto the target surface 106 of FIG. 1. As illustrated, the projection pattern 108_{A} may comprise a plurality of points of light, which, in the example of FIG. 2, are illustrated as dots. The dots may be arranged in a rectangular grid (e.g., comprising a plurality of rows and columns).

Both the distance sensor 102 and the external camera 104 may capture images of the projection pattern 108_{A}. In one example, the distance sensor 102 and the external camera 104 capture the respective images simultaneously (i.e., at the same instant in time). In another example, the distance sensor 102 and the external camera 104 may not necessarily capture the respective images simultaneously, but may capture the respective images while the projection pattern 108_{A} is projected from the same position of the distance sensor 102 (e.g., from Position A). The images captured by the distance sensor 102 and the external camera 104 will vary due to the different positions and settings of the distance sensor 102 and the external camera 104. FIG. 2, for instance, shows an example image 116 of the projection pattern 108_{A} captured by the distance sensor 102 and an example image 118 of the projection pattern 108_{A} captured by the external camera 104.

For each dot of the projection pattern 108_{A}, the distance sensor may compute a correlation between an image position (e.g., u,v coordinates) of the dot on image sensor of the imaging subsystem and a spatial position (e.g., x,y,z coordinates) of the dot on the target surface 106 (as detected from an image captured by the external camera 104). For instance, referring to FIG. 2 and taking a dot 110 of the projection pattern 108_{A} as an example, the spatial position of the dot 110 as calculated from Position A may be (x_{A}, y_{A}, z_{A}) (computed from an origin point O of the projection pattern 108_{A}). The correlation between the image position and spatial position from Position A may be stored in a memory of the distance sensor 102 (and/or in an external memory) as calibration data.

Then, the distance sensor 102 may be positioned at a second position, such as Position B, along the track 114. Position B in this case may have three-dimensional coordinates of (x,y,Z_{B}). In other words, the only difference between Position A and Position B is the distance from the target surface 106 (as indicated by the z coordinate). The distance sensor 102 may then project the projection pattern 108_{B} onto the target surface 106 from Position B.

The projection pattern 108_{B} is the same as the projection pattern 108_{A}, except that the appearance of the projection pattern (e.g., sizes of the dots) on the target surface 106 may vary with the distance from the distance sensor 102 to the target surface 106. For instance, referring back to FIG. 2, it can be seen that as the distance increases, the dots of the projection pattern (as well as the spaces between adjacent dots) appear to be larger. For instance, again taking dot 110 of the projection pattern 108_{B} as an example, the spatial position of the dot 110 as calculated from Position B may be (x_{B}, y_{B}, z_{B}). The correlation between the image position and spatial position from Position B may be computed and stored in a memory as calibration data.

The distance sensor 102 may be moved to a plurality of different positions (again, where the x and y coordinates of the positions are the same, and only the z coordinates differ), and the projection pattern may be projected and imaged at each of these positions, with the correlation between spatial position and image position at each position of the distance sensor 102 being stored as calibration data.

In the arrangement illustrated in FIG. 1, the coordinate reference (e.g., x, y, z) point of the system 100 is the same as the coordinate reference point 120 of the distance sensor 102. In one example, the mounting portion of the support 112 (i.e., the portion of the support 112 to which the distance sensor 102 is directly attached) is configured in a predetermined positional relationship with respect to this coordinate reference point 120. If the mounting portion of the support 112 is configured so that the position and direction of the mounting portion are determined based on the coordinate reference point 120 of the distance sensor 102, then the spatial position (e.g., x, y, z coordinates) of a point of the projection pattern (e.g., point 110) will be determined correctly for all devices including the distance sensor 102 and other devices (including the external camera 104). Proper configuration of the mounting portion could be achieved using a mounting plane, reference holes, and/or a rotation stop, for example. In other words, the (x, y, z) coordinates determined by the mounting portion of the support 112 will be copied to the distance sensor 102.

Moreover, although FIG. 1 illustrates the external camera 104 as being positioned on the same side of the target object 106 as the distance sensor 102, in another example, the external camera 104 may be positioned on the opposite side of the target object 106 from the distance sensor 102. In this case, the target object 106 may comprise a transparent or translucent screen, such that the positions of points of the projection pattern on the target object 106 are still observable by the external camera 104.

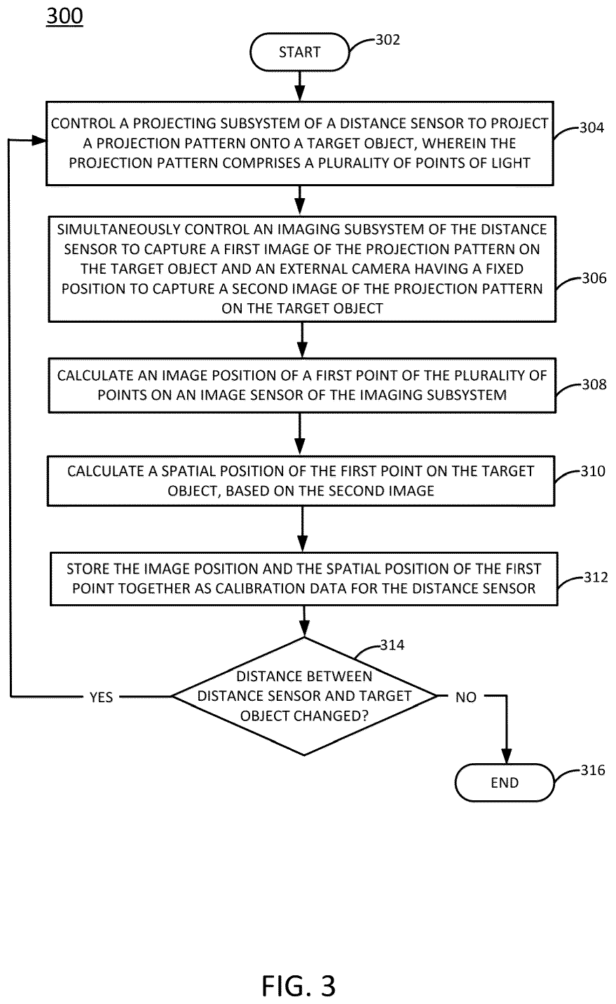

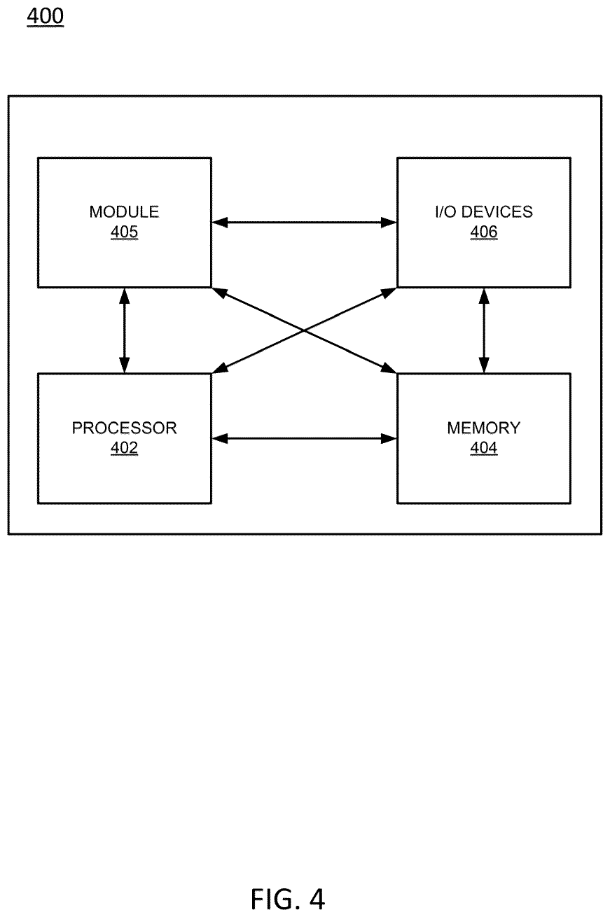

FIG. 3 is a flow diagram illustrating one example of a method 300 for calibrating a three-dimensional sensor for distance measurement, according to the present disclosure. In one example, the method 300 may be performed by the distance sensor 102 (or by a component of the distance sensor 102, such as a processor) illustrated in FIG. 1. In another example, the method 300 may be performed by a processing system, such as the processor 402 illustrated in FIG. 4 and discussed in further detail below. For the sake of example, the method 300 is described as being performed by a processing system.

The method 300 begins in step 302. In step 304, the processing system may control a projecting subsystem of a distance sensor to project a projection pattern onto a target object, where the projection pattern comprises a plurality of points of light.

In one example, the target object may comprise a flat, inflexible or flexible surface, such as a screen. The screen may have a uniform color and reflectance over its surface. The projecting subsystem of the distance sensor may create the projection pattern on the target object by projecting a plurality of beams of light in a wavelength that is invisible to the human eye (e.g., infrared). Each beam of light may create a point of light on the target object. Collectively, the plurality of points of light created by the plurality of beams may create a pattern on the target surface, i.e., the projection pattern. In one example, the projection pattern may arrange the plurality of points of light in an array (e.g., a plurality of rows and columns). For instance, the projection pattern may have an appearance similar to the projection patterns 108_{A} and 108_{B} illustrated in FIG. 2.

In step 306, the processing system may simultaneously control an imaging subsystem of the distance sensor to capture a first image of the projection pattern on the target object and an external camera having a fixed position to capture a second image of the projection pattern on the target object.

In one example, the imaging subsystem of the distance sensor may include a camera (hereinafter also referred to as an “internal camera”). The internal camera may include an image sensor that includes photodetectors capable of detecting one or more visible (i.e., visible to the human eye) wavelengths of light, such as red, green, and blue, as well as one or more invisible (i.e., invisible to the human eye) wavelengths of light, such as infrared.

In one example, the external camera also includes an image sensor that includes photodetectors capable of detecting one or more visible (i.e., visible to the human eye) wavelengths of light, such as red, green, and blue, as well as one or more invisible (i.e., invisible to the human eye) wavelengths of light, such as infrared. However, the external camera is separate from the distance sensor (i.e., is not contained within the same housing as the distance sensor's imaging subsystem, projecting subsystem, and processor). For instance, the external camera may be mounted in a fixed position, such that the external camera's position relative to the target object does not change (while the distance sensor's position relative to the target object can be changed in the z direction).

In step 308, the processing system may calculate an image position of a first point of the plurality of points on an image sensor of the imaging subsystem (of the distance sensor).

For instance, the processing system may calculate a set of (u, v) coordinates corresponding to a position of the first point on the image sensor of the imaging subsystem. Referring back to FIG. 2, for example, image 116 of the projection pattern 108_{A} captured by the distance sensor 102 shows a (u, v) coordinate position of the point 110 of the projection pattern 108_{A}. In one example, the image position of the first point on the image sensor of the imaging subsystem is determined using one or more known image processing techniques (e.g., feature point detection).

In step 310, the processing system may calculate a spatial position of the first point on the target object, based on the second image.

In one example, the x and y coordinates of the spatial position may be calculated based on the position of the first point's image position in the second image (e.g., using feature point detection techniques). Referring back to FIG. 2, for example, image 118 of the projection pattern 108_{A} captured by the external camera 104 shows a (u′, v′) coordinate position of the point 110 of the projection pattern 108_{A}. The z coordinate may be known from the position of the distance sensor (e.g., from the coordinate reference point of the distance sensor, making the distance measurement mechanically clear).

In step 312, the processing system may store the image position and the spatial position together as calibration data for the distance sensor.

In one example, the spatial position (e.g., x, y, z) and image position (u, v) are stored together, i.e., in such a way as to preserve the relationship of the spatial position and the image position to the same (first) point. Thus, the data stored for the first point may comprise: (z, (x, y), (u, v)). In one example, the spatial position and image position may be stored in a local memory. Additionally or alternatively, the spatial position and image position may be stored in a remote storage location, such as a remote database.

It should be noted that steps 308-312 may be performed for more than one point of the plurality of points. For instance, image positions in the first and second images may be calculated and stored for every point of the plurality of points of the projection pattern. In another example, to save processing power and time, the image positions may be explicitly calculated for fewer than all of the plurality of points; however, points for which the image positions have not been explicitly calculated may be interpolated or extrapolated based on the image positions for the points that have been explicitly calculated.

In step 314, the processing system may determine whether the distance between the distance sensor and the target object has changed.

As discussed above, calibration of the distance sensor may involve capturing calibration data at a number of different distances, e.g., where the x and y coordinates of the distance sensor's position relative to the target object does not change, but the z coordinate does change.

For instance, in one example, the processing system may be programmed to calculate image positions of the same point(s) from multiple different distances (i.e., distances between the target object and the distance sensor). In one example, the number and/or values of these multiple different distances may be predefined. For example the processing system may be programmed to obtain calibration data from at least n different distances. In a further example, the values of the n different distances may also be predefined (e.g., from 2 feet away, 5 feet away, 10 feet away, and so on).

Steps 304-312 may be performed at a plurality of different distances between the distance sensor and the target object. Thus, a first iteration of step 304 may be performed at a first distance between the distance sensor and the target object. However, step 304 (as well as subsequent steps 306-312) may later be repeated at different (e.g., second, third, fourth, etc.) distances. The number of different distances at which steps 304-312 may be repeated may depend on a desired level of accuracy (e.g., more calibration data may improve accuracy), desired processing and calibration time (e.g., it may take more time and processing to acquire more calibration data), and/or other factors. However, at each iteration of steps 304-312, the distance of the distance sensor from the target object is known.

If the processing system concludes in step 314 that the distance between the distance sensor and the target object has changed, then the method 300 may return to step 304 and may proceed as described above (e.g., repeating steps 304-312) to obtain calibration data at a new position.

If, however, the processing system concludes in step 314 that the distance between the distance sensor and the target object has not changed (e.g., sufficient calibration data has been gathered), then the method 300 may end in step 316.

Thus, the method 300 (and system 100 illustrated in FIG. 1) provides an improved method for calibrating a distance sensor. The method 300 does not require the use of calibration patterns, which reduces complications (e.g., illumination, exposure adjustment, etc.) introduced when attempting to process images of a calibration pattern and a projection pattern at the same time. Moreover, the method 300, unlike techniques that utilize calibration patterns, does not require analogous calculations of the distance sensor imaging subsystem's position and specifications (e.g., angle of view), resulting in shorter calibration time and reduced calibration errors.

It should be noted that although not explicitly specified, some of the blocks, functions, or operations of the method 300 described above may include storing, displaying and/or outputting for a particular application. In other words, any data, records, fields, and/or intermediate results discussed in the method 300 can be stored, displayed, and/or outputted to another device depending on the particular application. Furthermore, blocks, functions, or operations in FIG. 3 that recite a determining operation, or involve a decision, do not imply that both branches of the determining operation are practiced. In other words, one of the branches of the determining operation may not be performed, depending on the results of the determining operation.

FIG. 4 depicts a high-level block diagram of an example electronic device for calibrating a three-dimensional distance sensor. As such, the electronic device 400 may be implemented as a processor of an electronic device or system, such as a distance sensor.

As depicted in FIG. 4, the electronic device 400 comprises a hardware processor element 402, e.g., a central processing unit (CPU), a microprocessor, or a multi-core processor, a memory 404, e.g., random access memory (RAM) and/or read only memory (ROM), a module 405 for calibrating a three-dimensional distance sensor, and various input/output devices 406, e.g., storage devices, including but not limited to, a tape drive, a floppy drive, a hard disk drive or a compact disk drive, a receiver, a transmitter, a display, an output port, an input port, and a user input device, such as a keyboard, a keypad, a mouse, a microphone, a camera, a laser light source, an LED light source, and the like.

Although one processor element is shown, it should be noted that the electronic device 400 may employ a plurality of processor elements. Furthermore, although one electronic device 400 is shown in the figure, if the method(s) as discussed above is implemented in a distributed or parallel manner for a particular illustrative example, i.e., the blocks of the above method(s) or the entire method(s) are implemented across multiple or parallel electronic devices, then the electronic device 400 of this figure is intended to represent each of those multiple electronic devices.

It should be noted that the present disclosure can be implemented by machine readable instructions and/or in a combination of machine readable instructions and hardware, e.g., using application specific integrated circuits (ASIC), a programmable logic array (PLA), including a field-programmable gate array (FPGA), or a state machine deployed on a hardware device, a computer or any other hardware equivalents, e.g., computer readable instructions pertaining to the method(s) discussed above can be used to configure a hardware processor to perform the blocks, functions and/or operations of the above disclosed method(s).

In one example, instructions and data for the present module or process 405 for calibrating a three-dimensional distance sensor, e.g., machine readable instructions can be loaded into memory 404 and executed by hardware processor element 402 to implement the blocks, functions or operations as discussed above in connection with the method 300. Furthermore, when a hardware processor executes instructions to perform “operations”, this could include the hardware processor performing the operations directly and/or facilitating, directing, or cooperating with another hardware device or component, e.g., a co-processor and the like, to perform the operations.

The processor executing the machine readable instructions relating to the above described method(s) can be perceived as a programmed processor or a specialized processor. As such, the present module 405 for calibrating a three-dimensional distance sensor of the present disclosure can be stored on a tangible or physical (broadly non-transitory) computer-readable storage device or medium, e.g., volatile memory, non-volatile memory, ROM memory, RAM memory, magnetic or optical drive, device or diskette and the like. More specifically, the computer-readable storage device may comprise any physical devices that provide the ability to store information such as data and/or instructions to be accessed by a processor or an electronic device such as a computer or a controller of a safety sensor system.

It will be appreciated that variants of the above-disclosed and other features and functions, or alternatives thereof, may be combined into many other different systems or applications. Various presently unforeseen or unanticipated alternatives, modifications, or variations therein may be subsequently made which are also intended to be encompassed by the following claims.

What is claimed is:

1. A method comprising:
controlling, by a processing system of a distance sensor, a projecting subsystem of the distance sensor to project a projection pattern onto a target object, wherein the projection pattern comprises a plurality of points of light;
controlling, by the processing system, an imaging subsystem of the distance sensor to capture a first image of the projection pattern on the target object and an external camera having a fixed position to capture a second image of the projection pattern on the target object;
calculating, by the processing system, an image position of a first point of the plurality of points on an image sensor of the imaging subsystem;
calculating, by the processing system, a spatial position of the first point on the target object, based on the second image; and
storing, by the processing system, the image position and the spatial position together as calibration data for the distance sensor.

2. The method of claim 1, wherein the image position comprises a set of (u, v) coordinates, and the spatial position comprises a set of (x, y, z) coordinates.

3. The method of claim 2, wherein the set of (u, v) coordinates is obtained using a feature point detection technique.

4. The method of claim 2, wherein a z coordinate of the set of (x, y, z) coordinates is known from a coordinate reference point of the imaging subsystem of the distance sensor.

5. The method of claim 4, wherein the distance sensor is mounted to a support that is movable along a track to change a distance between the distance sensor and the target object.

6. The method of claim 5, wherein a portion of the support to which the distance sensor is directly attached is configured in a predetermined positional relationship with respect to the coordinate reference point of the imaging subsystem of the distance sensor.

7. The method of claim 1, wherein the controlling the projecting subsystem, the controlling the imaging subsystem and the external camera, the calculating the image position of the first point, the calculating the spatial position of the first point, and the storing the image position and the spatial position are repeated for a plurality of different distances between the target object and the distance sensor.

8. The method of claim 7, wherein x and y coordinates of a position of the distance sensor remain constant over all distances of the plurality of different distances, and only a z coordinate of the position of the distance sensor changes over the all distances.

9. The method of claim 8, wherein the controlling the projecting subsystem, the controlling the imaging subsystem and the external camera, the calculating the image position, the calculating the spatial position, the storing the image position and the spatial position, and the repeating are performed for all points of the plurality of points.

10. The method of claim 1, wherein the external camera comprises a camera that is separate from a housing of the distance sensor that contains the projecting subsystem, the imaging subsystem, and the processing system.

11. The method of claim 1, wherein the external camera is one of a plurality of external cameras, and wherein each external camera of the plurality of external cameras comprises a camera that is separate from a housing of the distance sensor that contains the projecting subsystem, the imaging subsystem, and the processing system.

12. The method of claim 11, wherein each external camera of the plurality of external cameras has a different fixed position.

13. The method of claim 1, wherein the target object comprises a flat screen.

14. The method of claim 13, wherein the flat screen has a uniform color and a uniform reflectance.

15. The method of claim 14, wherein the flat screen is transparent or translucent.

16. The method of claim 15, wherein the external camera is positioned on an opposite side of the flat screen from the distance sensor.

17. The method of claim 1, wherein the first image and the second image are captured simultaneously.

18. The method of claim 1, wherein the first image and the second image are captured at different times, but a distance between the distance sensor and the target object at a time of capture of the first image is equal to a distance between the distance sensor and the target object at a time of capture of the second image.

19. A non-transitory machine-readable storage medium encoded with instructions executable by a processor of a distance sensor, wherein, when executed, the instructions cause the processor to perform operations, the operations comprising:
controlling a projecting subsystem of the distance sensor to project a projection pattern onto a target object, wherein the projection pattern comprises a plurality of points of light;
controlling an imaging subsystem of the distance sensor to capture a first image of the projection pattern on the target object and an external camera having a fixed position to capture a second image of the projection pattern on the target object;
calculating an image position of a first point of the plurality of points on an image sensor of the imaging subsystem;
calculating a spatial position of the first point on the target object, based on the second image; and
storing the image position and the spatial position together as calibration data for the distance sensor.

20. An apparatus comprising:
a processing system including at least one processor; and
a non-transitory machine-readable storage medium encoded with instructions executable by the processing system, wherein, when executed, the instructions cause the processing system to perform operations, the operations comprising:
controlling a projecting subsystem of the distance sensor to project a projection pattern onto a target object, wherein the projection pattern comprises a plurality of points of light;
controlling an imaging subsystem of the distance sensor to capture a first image of the projection pattern on the target object and an external camera having a fixed position to capture a second image of the projection pattern on the target object;
calculating an image position of a first point of the plurality of points on an image sensor of the imaging subsystem;
calculating a spatial position of the first point on the target object, based on the second image; and
storing the image position and the spatial position together as calibration data for the distance sensor.
